(19) United States
(12) Patent Application Publication
(10) Pub. No.: US 2025/0200362 A1
(43) Pub. Date: Jun. 19, 2025

(54) INFINITE RESERVOIR TRANSFORMER

(71) Applicant: YE Ventures, LLC, Baltimore, MD (US)

(72) Inventors: Jia XU, Hoboken, NJ (US); Md KOWSHER, Jersey City, NJ (US)

(21) Appl. No.: 18/780,055

(22) Filed: Jul. 22, 2024

Related U.S. Application Data
(60) Provisional application No. 63/515,035, filed on Jul. 21, 2023.

(51) Int. Cl. G06N 3/08; G06N 3/045; G06N 3/048

(52) U.S. Cl. CPC G06N 3/08; G06N 3/045; G06N 3/048

(57) ABSTRACT

Provided is a method for modeling variable-distanced input dependencies. The method comprises providing non-linear readouts using attentional neural networks to replace the linear readouts and learning, via the non-linear readout reservoir, sample dependencies in the complete dataset. The learning complements the transformer that only handles the dependencies within a sample in a short context. The learning long-sequential inputs also improves BERT and Blenderbot performance and significantly increases prediction accuracy in language modeling, text classification, and dialogue modelling tasks over the state-of-the-art.

### CROSS-REFERENCE TO RELATED APPLICATIONS

This application claims benefit to U.S. Provisional Patent Application No. 63/515,035, filed Jul. 21, 2023, the disclosure of which is incorporated herein in its entirety, by reference.

### FIELD OF TECHNOLOGY

The present relates to artificial intelligence technologies, specifically to neural network architectures and natural language processing systems.

### BACKGROUND

Transformer has updated state-of-the-art in a wide range of AI tasks including but not limited to NLP, computer vision, bioinformatics, etc. (Vaswani et al., 2017; Devlin et al., 2018; Dosovitskiy et al., 2020). One important limitation of Transformer is the quadratic time and memory complexity of the input length, e.g., BERT has a restriction of 512 input tokens and GPT-2 1024 for efficiency, although long sequential inputs can be extremely useful to learn contextual information.

For example, in language understanding, words have different meanings in different context, like “TAG” refers a markup syntax in language in NLP literature but means to “chase down the others” in games. Another example is dialogue modeling, the lack of effective contextual understanding can lead to incoherent or irrelevant responses in longer conversations, restricting the model capacity to engage in sustained and coherent dialogue. Therefore, it is urgent that Transformer's length restriction be solved so that long histories can be retained and utilized.

A number of studies have investigated how to increase Transformer input lengths, such as (Bertsch et al., 2023; Tay et al., 2022; Kitaev et al., 2020; Kim and Cho, 2020; Zhou et al., 2021; Guo et al., 2021; Beltagy et al., 2020; Choromanski et al., 2020; Katharopoulos et al., 2020; Hua et al., 2022; Ma et al., 2021). These existing solutions, however, rely on modifying the attention model with assumptions, so the resulting input length is extended only to a fixed value, making it impossible for learning from arbitrary long sequences.

### SUMMARY

Given the aforementioned deficiencies, there is a critical need for a novel reservoir model with non-linear readouts makes any-input-length Transformer possible. While Transformer has revolutionized NLP in many tasks, such as BERT, its limitation of the quadratic time and memory complexities on input length largely hinders its scalability for modeling long sequences. Conventional methods only increase the input to a fixed length. We enhance Transformer with reservoir computing to model variable-distanced input dependencies. Reservoir requires relative small training data sets and computing resources and is a best-in-class algorithm ideally for NLP tasks requiring long-time memory.

To strengthen the learning capabilities, we introduce a new form of the reservoir with non-linear readouts using attentional neural networks to replace the linear readouts. Our non-linear readout reservoir learns sample dependencies in the complete dataset, complementing the Transformer that only handles the dependencies within a sample in a short context. Experiments show that learning long-sequential inputs improves BERT and Blenderbot performance and significantly increases our prediction accuracy in language modeling, text classification, and dialogue modelling tasks over the state-of-the-art.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 illustrates interspersing reservoir layers in transformer.

FIG. 2 illustrates reservoir and RNN for BERT

FIG. 3 illustrates increasing the number of recurrent memory units.

FIG. 4 is a block diagram of an exemplary computing device configured for implementing one or more embodiments of the present disclosure.

### DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

A reservoir method, constructed in accordance with the embodiments, makes it possible for Transformer to process an infinite number of input tokens. Reservoir Computing (RC) is a class of simple and efficient Recurrent Neural Networks where internal weights are fixed at random, and only a linear output layer is trained. Reservoir computing is recognized for its simplicity and computational complexity advantages for processing sequential data (Gauthier et al., 2021).

Reservoir requires a small number of training data samples and computing resources and is a best-in-class algorithm, for NLP able to take long conversational text into account with a small memory space (Gauthier et al., 2021). The role of the reservoir in our context is to convert sequential inputs into a high-dimensional space so that a relatively simple learning algorithm can efficiently read out the features of the inputs.

We enhance Transformer with reservoir computing to model an arbitrarily long sequence of inputs. Improving Transformer using reservoir models is expected to (1) enable infinite input length; (2) significantly enhance accuracy on prediction tasks with limited training samples; (3) generalize learning resulting in higher model robustness. To the best of our knowledge, ours is the first study to integrate reservoirs into Transformers for improving their input-length capabilities.

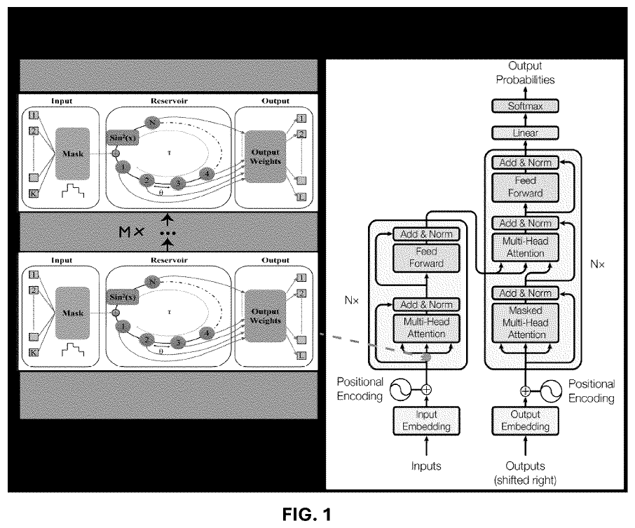

FIG. 1 shows the architecture of our reservoir enhanced Transformer that intersperses reservoir layers into the Transformer. Our model reads each sample sequentially from the entire training data and learns sample dependency using efficient training of the reservoir while maintaining learning on each sample using a Transformer. Reservoir models the dependency of the current sample given the previous sample.

For each sample, we use Transformer to learn time-step dependencies within one sample. In this way, we learn the sample dependency using the efficient training of the reservoir while maintaining the conventional learning on each sample time-stamp using a Transformer. Each Transformer encoder layer receives the inputs, and their reservoir module processes encoder inputs. The decoder layer interspersion is performed analogously.

While the reservoir allows long input to Transformer, its linear readout can be expensive. The Transformer reads the reservoir output. The number of reservoir nodes is N2, given N as the input and output reservoir size. Therefore, the Transformer input length increases when we increase the reservoir nodes. This slows down the training a lot. As our novel solution, instead of the linear readout, we introduce a nonlinear readout to reduce the output dimension of the reservoir, i.e., the input di dimension of the Transformer, because the nonlinear function has more expressive power than a linear separator.

Furthermore, we stack M reservoir inspired by (Grezes, 2014) for robustness that further improves our prediction performance (M=1 by default). We also use an RNN to model sample dependency on shorter context for more accurate modeling and use reservoirs to model longer dependency among samples.

The nonlinear readout of the reservoir significantly improves the Transformer accuracy by taking arbitrary long input sequences in learning while generating low dimensional outputs. Our nonlinear readout reservoir excels linear readout that handles extremely long input sequences without increasing training data sets or much on the training time, heralding the next generation of Transformer.

The contributions are threefold: a) We introduce reservoir computing to handle arbitrary long input of Transformer. b) We enhance the conventional reservoir computing model by replacing linear with a nonlinear readout for dimension reduction and better feature learning. c) We integrate the reservoir with the recurrent memory to encourage more focused learning of medium-term history. d) We collect experimental evidence that our reservoir Transformer significantly enhances the performance of the Transformer on various NLP tasks showcasing the advancement of BERT and Blenderbot.

### 2. Reservoir Transformer

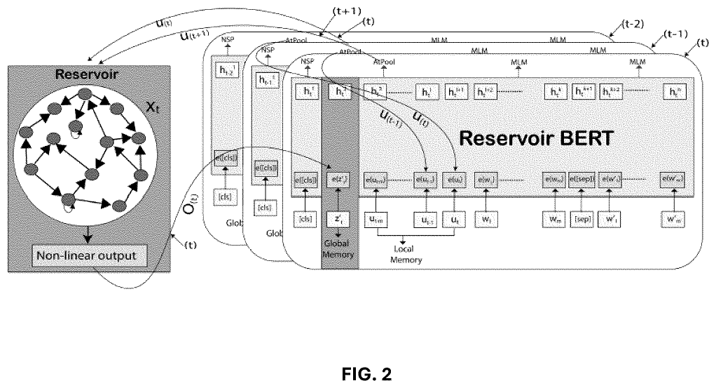

The reservoir Transformer integrates the reservoir and Transformer, as illustrated in FIG. 2. It comprises reservoir components, nonlinear (e.g., attentional) or linear readout interface between reservoir and Transformer. Reservoir, reservoir embedding, recurrent memory, attention pooling, and Transformer are combined one after another to train the reservoir Transformer end-to-end.

### 2.1 Reservoir

Reservoir Computing (RC) is a Recurrent Neural Network that receives a sequential input of previous states xt-1 and attention pooling output of the previous states ut ∈Rd, for t ∈ N. We denote by xt ∈RN the current state of the reservoir, N is the number of neurons in the reservoir. Its dynamics is given by the following recurrent equation:

$${x}_{t} = \frac{1}{\sqrt{N}} f ( {W}_{r} {x}_{t - 1} + {W}_{i} {u}_{t} ) , \qquad ( 1 )$$

where Wr ∈RN×N and Wi ∈Rd×N are respectively the reservoir and input weight matrices. They are fixed and random: each weight is drawn according to an i.i.d. Gaussian distribution with variances σr 2 and σi 2, respectively.

### 2.2 Linear Readout

We use the reservoir to learn how to predict a given output ot with linear readout given an input state xt at time t. The output predicted by the network ot is obtained after a final layer:

$${o}_{t} = {W}_{o} {x}_{t} \qquad ( 2 )$$

Since only these output weights Wo are trained, the optimization problem boils down to linear regression. Training is typically not a limiting factor in RC, in sharp contrast with other neural network architectures. The expressiveness and power of Reservoir Computing rather lies in the high-dimensional non-linear dynamics of the reservoir.

### 2.3 Nonlinear Readout

Instead of linear readout, we introduce nonlinear readout for better prediction performance. Reservoir handles long inputs. The time complexity of a Transformer is O(T·d)2, where τ is the input length, and d is the dimensionality of the model, also known as the hidden size. Thus, the more time steps we consider in the input, the longer it takes for training Transformer in quadratic time. As a contrast, reservoir encode each time step as its own state. The whole history is kept in its learning parameters without increasing the input length. Therefore, reservoir performs better for long sequential inputs.

One downside of the reservoir is that if the τ is large, then the Transformer training is slow due to its complexity of T2. A linear readout of reservoir needs much larger size of T to have the same expressive power as the nonlinear readout. Therefore, we introduce nonlinear readout layers which works quite well for RC output dimension deduction and the final prediction performance.

Readout with Attention Mechanisms: Consequently, we use attention mechanisms (Vaswani et al., 2017) to capture input features importance for decision making, alleviating the problem of vanishing gradient of long-distance dependency. There have been various implementations of attention mechanisms. We realize our attention model as in (PyTorch, 2023).

Attention mechanism for processing sequential data that considers the context for each timestamp. W and b are the weight and bias of this representation and the hyperbolic tangent function tanh(·) is a non-linear activation. xt is the current state from reservoir at time t. The attention weight a is a softmax of e. Finally, the output is

$${h}_{i , j} = tanh ( {( {x}_{t}^{i} )}^{T} {W}_{t} + {( {x}_{t}^{j} )}^{T} {W}_{x} + {b}_{i} ) {e}_{i , j} = σ ( {W}_{a} {h}_{i , j} + {b}_{a} ) {a}_{i , j} = \frac{exp ( {e}_{i , j} )}{\sum ( exp ( {e}_{i , j} ) )} {o}_{t} = {\{ {\sum }_{j} {a}_{i , j} {x}_{j} \}}_{i = 1}^{d} \qquad ( 3 )$$

Here, the superscript i and j are the i-th and j-th component of xt. The equation calculates the hidden state representation hi,j and attention weights ai,j for a specific pair of time steps i and j within the sequence. The hidden state hi,j captures the representation at the given pair of time steps, while the attention weights ai,j determine the importance or relevance of the context vectors at those time steps.

### 2.4 Reservoir in Recurrent Memory

The reservoir and its readout can be directly attached to Transformer as in FIG. 2. This allows the handling of the infinite long input length. However, the modeling is not precise enough. Therefore, we add recurrent memory to handle the medium-term context so that far-away samples will be taken care of by the reservoir and close previous samples will be learned from the recurrent neural networks.

As input, each sentence pair is read one by one, and we consider that each sentence pair indicates a time-associated state t. Let w1 t, . . . , wm t represents the input sequence of tokens of the t-th sentence, and w′1t, . . . , w′m′ t represents the input sequence of tokens of the t-th sentence. We assume that each sentence in the pair is padded or truncated to a fixed length of m and m′, respectively.

Taking BERT as an example of utilizing a reservoir Transformer, as in FIG. 1, we take a sequence of tokens as input to the reservoir BERT. The first input token is the embedding of ‘[CLS]’, meaning it is a classification task. We use e(·) for the embedding function. The next input token is the global memory from the reservoir output embedding e(z′ t) formalized as following:

$${z}_{t}^{′} = κ {u}_{t} + ( 1 - κ ) ( {o}_{t} ) \qquad ( 4 )$$

z′t denotes the Transformer M input with κ as a learnable parameter indicating adjusting the weights of the current input and reservoir inputs carrying on all histories. Thus, z′ t is the input to the recurrent memory.

Algorithm 1 Training algorithm of Deep Reservoir
Computing with Recurrent Transformer

Require:
S_{i:T, yi:T} : Dataset

| | |
|---|---|
| function R( [symbol] ) | [symbol] Reservoir |
| $\text{?} ← \frac{1}{\sqrt{N}} f ( {W}_{r} {x}_{t - 1} + \text{?} )$ | [symbol] By |

equation 1

| | |
|---|---|
| o_{ι} ← {Σⱼα_{i,x}_{ⱼ}}ᵢ₌₁^{d} | [symbol] By equation 3 |

```
  end function
Ensure: Optimize Pr(yᵢ|S_{1:t}) distribution by
  learning a model M (.)
```

| | |
|---|---|
| Wᵢ, Wᵣ ← [symbol] (0, 1) | [symbol] Weights initialization of |

Reservoir

| | |
|---|---|
| σ ← [symbol] (0, 1) | [symbol] Weights initialization of |

Reservoir non-linear output

| | |
|---|---|
| ϕ ← [symbol] (0, 1) | [symbol] Weights initialization of |

```
  Transformer M (.)
  while epoch < epochs do
    while t < T do
```

| | |
|---|---|
| oₜ ← R(uₜ; Wᵢ, Wᵣ, σ) | [symbol] Non- |

```
  linear readout from R(.) reservoir described in
  equation 3
```

| | |
|---|---|
| z′ₜ ← κuₜ + (1 − κ)(oₜ) | [symbol] Reservoir |

```
  output embedding by 4
      zₜ = e(z′ₜ) ⊕ e(u_{t-T}) ⊕ . . . ⊕ e(uₜ) ⊕
  e(w₁) ⊕ . . . ⊕ e(wₘ) ⊕ e(w₁) ⊕ . . . ⊕ e(w_{m′}) [symbol]
  Concatenation of all embedding described in
  described in 5
      yₜ ← M(zₜ; ϕ)
    end while
```

| | |
|---|---|
| loss ← [symbol] _{CE} (y_{1:T}, y_{1:T}) | [symbol] Calculating loss |

for every time step z by equation 12

| | |
|---|---|
| ϕ, σ, [symbol] , [symbol] ← update | [symbol] Update parameters |

end while [symbol]
indicates data missing or illegible when filed

The next sequence of tokens is the embeddings of the attention pooling output sequence from the previous states (sentences) h1, . . . , hτ, . . . , ht, and previous recurrent memory for the previous states (sentences). τ is a hyperparameter and we set the value as 15 for Blenderbot and 50 for the BERT by default. After that, we input the embeddings of the input and the output sentences of the t-th sentence pair separated by embedding a function token of ‘SEP’. The embedding e(·) is a trainable function. Formally, the input to the reservoir BERT is constructed as follows:

$${z}_{t} = e ( {z}_{t}^{\vert ′} ) ⊕ e ( {v}_{t - τ} ) ⊕ … ⊕ e ( {u}_{t} ) ⊕ e ( {w}_{1} ) ⊕ … ⊕ e ( {w}_{m} ) ⊕ e ( {w}_{1} ) ⊕ … ⊕ e ( {w}_{m ′} ) \qquad ( 5 )$$

where ⊕ is the concatenation operator, and u(·) is the attention pooling from the hidden state of the previous states (sentences) that will be discussed in Section 2.6.

### 2.5 Transformer

Mathematically, we denote the Transformer as M(·). The output of the recurrent memory with reservoir is the input to the Transformer M(·):

$${y}_{t} = M ( {z}_{t} ) \qquad ( 6 )$$

The yt the output of our classifier, for example, BERT, at the t-th time.

We use the standard implementation of Transformer (Vaswani et al., 2017). In Transformer M(·), the attention is calculated by a scaled dotproduct of key ki and query qj:

$${e}_{i , j} = \frac{{( {W}^{K} {k}_{i} )}^{T} ( {W}^{Q} {q}_{j} )}{\sqrt{{d}_{k}}} , \qquad ( 7 )$$

where dk is the dimension of ki, and K and Q represents the key matrix and query matrix, respectively. WK,WQ ∈Rdmodelxdk are parameter matrices, and dmodel is the output dimension of attention and embedding layer. The attention weight is computed by applying a softmax function over eij:

$${a}_{ij} = \frac{exp {e}_{ij}}{{\sum }_{k = 1}^{I} exp {e}_{kj}} \qquad ( 8 )$$

The transformer encoder and decoder have multiple layers. Within a layer, there are multiple heads. Each head has its independently learned queries and keys, which means each head has different attention. We used the sum of attention of all heads from the last layer for attention information extraction. Transformer uses Sine and Cosine functions of different frequencies for positional embedding calculation: ϵ(pi,2l)=sin(pi/100002l/dmodel) and ϵ(pi,2l+1)=cos(pi/1000021/dmodel), where 1 represents the indices of each dimension of the positional embedding, and dmodel is the output dimension of the attention layer and embedding layer.

### 2.6 Attention Pooling

As illustrated in FIG. 2, the output of the Transformer of each position is a n size vector, but the input to the reservoir needs to be a scalar value. A standard method to convert the Transformer output to the reservoir input is to apply max pooling. However, this method loses information from multiple dimensions of the Transformer output. Therefore, we apply attention pooling (Alam et al., 2023) to achieve better performance.

The attention pooling mechanism for t aims to derive a summary representation, denoted as ut, taking {h1t, . . . , hnt} as inputs, by emphasizing frames that contribute the most to the overall understanding of the input, formalized as follows:

$${u}_{t} - {\sum }_{i = 1}^{n} {α}_{i} {h}_{t}^{i} , \qquad ( 9 )$$

where αt ∈[0, 1] denotes the normalized weight assigned to each frame representation ht. The weight at is determined by the relevance or importance of the corresponding frame in the context of the given task. To compute at, we employ a normalization mechanism that ensures the weights sum up to 1:

$${α}_{i} = \frac{exp ( {e}_{i} )}{{\sum }_{i = 1}^{d} ( {e}_{i} )} \qquad ( 10 )$$

In Equation 10, ei represents the intermediate score assigned to the frame representation hit. This score is calculated by applying a transformation to hit using trainable parameters vi, Wi, and bi, followed by a hyperbolic tangent operation:

$${e}_{i} = {v}_{i} tanh ( {W}_{i} {h}_{t}^{i} + {b}_{i} ) \qquad ( 11 )$$

The parameters vi, Wi, and bi are learned during the model training process, allowing the attention pooling mechanism to adapt and assign appropriate weights to each frame representation based on its relevance to the task.

### 2.7 Training

We utilize two Transformer implementations: one on BERT and the other one on Blenderbot. The architecture and hyperparameter settings are the default ones from the original papers (Devlin et al., 2018; Roller et al., 2020). During the training process, we utilize the Adam optimizer with a decay of 0.01 and a linear schedule learning rate starting from 2e-5. However, in mask language modelling (MLM) tasks, the cross-entropy loss is commonly employed to optimize the model's predictions. In MLM, a certain percentage of input tokens are randomly masked to train the model to predict the masked tokens based on their surrounding context.

Mathematically, the cross-entropy loss is defined as follows:

$${ℒ}_{CE} = - \frac{1}{T} {\sum }_{i = 1}^{T} {\sum }_{j = 1}^{V} {y}_{ij} log ( {p}_{ij} ) , \qquad ( 12 )$$

where τ is the total number of instances, V is the size of the vocabulary, yij is the binary indicator (0 or 1) for whether the true label is j for the i-th instance, and pij is the predicted probability of the i-th instance belonging to class j.

In mask language modeling, the input sequences are modified by randomly replacing some tokens with a special [MASK] token. The model's objective is then to predict the original tokens based on the context provided by the surrounding tokens.

The cross-entropy loss is calculated by comparing the predicted probabilities of the masked tokens with their true labels.

Additionally, BERT often includes next-sentence prediction (NSP) as an auxiliary task during pretraining. NSP determines whether two sentences in a pair are contiguous in the original text. This task helps the model capture relationships between sentences. Cross-entropy loss is also used to optimize the predictions of sentence pairs for the NSP task.

Furthermore, in token generation models like BlenderBot, the Cross-entropy loss is again employed to train these models, comparing the predicted probability distribution of tokens in the generated sequence with the target sequence.

We train our model by adopting the methodology outlined in Algorithm 1. The pretraining phase encompasses two models: BERT and Blenderbot.

For BERT, we adopt the parameter settings described in the original BERT paper by Devlin et al. (Devlin et al., 2018). Our primary focus lies in optimizing the Masked Language Model (MLM) and Next Sentence Prediction (NSP) objectives for the pretraining model M. Pretraining, the Reservoir Bert model, involves employing the Book Corpus dataset (Zhu et al., 2015) and fine-tuning with the WikiText-103 dataset (Merity et al., 2016). In the reservoir setting, we use 3000 units with a spectral radius of 0.5. The leaky rate is set to 0.35, and the sparsity value is set to 0.3. Furthermore, we allocate 50 units of memory for recurrent settings.

Similar to BERT, training the Blenderbot model adheres to the original Blenderbot hyperparameters outlined by Roller et al. (Roller et al., 2020). Pretraining of Reservoir Blenderbot involves utilizing the Soda dataset (Kim et al., 2022), followed by fine-tuning with the Blend Skills Talk dataset (Smith et al., 2020). In the reservoir setting of Blenderbot, we use 3000 units with a spectral radius of 0.5. The leaky rate is set to 0.35, and the sparsity value is set to 0.3. Additionally, we reserve 15 units of memory for recurrent settings.

### 3. Experiments

We experiment on three NLP tasks to demonstrate that our reservoir Transformer outperforms state-of-the-art Deep Neural Network architectures by handling arbitrarily long input sequences.

The first task is language modeling at the word level. We use the WikiText-103 dataset (Merity et al., 2016) and use perplexity as the performance evaluation criterion. The second task is text classification. We use three datasets: hyperpartisan news detection (Kiesel et al., 2019), 20Newsgroups (Lang, 1995), and EURLEX-57K (Chalkidis et al., 2019). The third task is dialogue modeling, and we use the user ratings for the real-world evaluation criterion.

### 3.1 Language Modelling

We conduct language modeling experiments on the WikiText-103 dataset (Merity et al., 2018), which consists of 103 million words extracted from English Wikipedia articles, in order to assess the performance of various language models. Table 1 provides an overview of the models utilized in the experiments, along with their corresponding perplexity scores. Perplexity serves as a metric to gauge a language model's proficiency in predicting subsequent words within a sequence.

Among the evaluated models, InfR BERT emerges as the highest-performing model, achieving an impressive perplexity score of 15.62. The Routing Transformer model closely follows with a perplexity score of 15.80. Noteworthy performance is also observed in the kNN-LM model with a perplexity score of 15.79, as well as the Hybrid H3 model with a score of 16.9. A comparison of these results with those of previously published models reveals a substantial enhancement in language modelling performance. The Transformer-N model attains the highest perplexity score of 25.2 in the table, whereas our reservoir BERT model achieves the lowest perplexity score of 15.62, showcasing a significant advancement in language modeling capabilities.

TABLE 1
Language modeling on WikiText-103.

| Model Name | PPL |
|---|---|
| Transformer-N (Sun and Iyyer, 2021) | 25.2 |
| Transformer-XL Standard (Dai et al., 2019) | 24.0 |
| Feedback Transformer (Fan et al., 2020) | 22.4 |
| BERT-Large-CAS (Wang et al., 2019) | 20.4 |
| Transformer-XL Large (Dai et al., 2019) | 18.3 |
| Feedback Transformer (Fan et al., 2020) | 18.2 |
| Shortformer (Press et al., 2020) | 18.15 |
| Sandwich Transformer (Press et al., 2019) | 17.96 |
| Sega Transformer-XL (Bai et al., 2021) | 17.10 |
| Compressive Transformer (Rae et al., 2019) | 17.10 |
| Hybrid H3 (Dao et al., 2022) | 16.90 |
| kNN-LM (Khandelwal et al., 2019) | 15.79 |
| Routing Transformer (Roy et al., 2021) | 15.80 |
| Reservoir BERT | 15.62 |

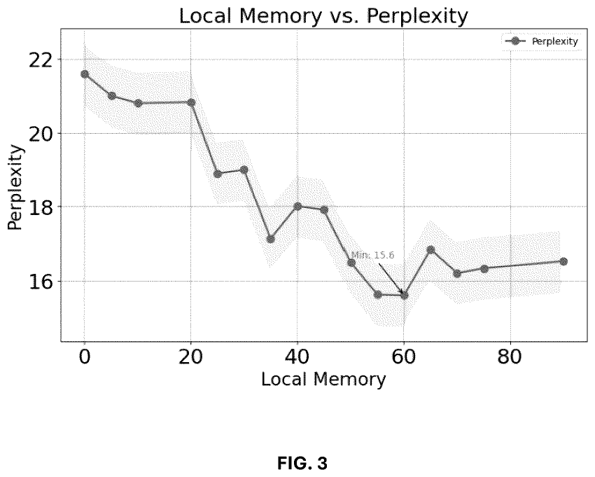

We perform an ablation test to analyze the parameter settings of our model. FIG. 3 illustrates the impact of increasing the number of recurrent memory on perplexity. The x-axis represents the values of the recurrent memory, while the y-axis represents the corresponding perplexity values.

### 3.2 Text Classification

Table 4 presents the results of hyperpartisan news detection (HND), 20Newsgroups (20N), and EURLEX-57K (E57K), respectively. The datasets were split into training, validation, and test sets following the approach outlined in (Park et al., 2022). The evaluation metric used to measure performance is the micro F1 score. To overcome this limitation of lengthy sequences, the approach employs a technique called segmenting, which divides the sequences into smaller parts. Additionally, memory states from preceding segments are transferred to the current segments, allowing for recurrent capabilities.

Consequently, this memory-passing process removes any limitations on the length of the input sequence. For the purposes of this study, a total of four segments are considered and noted the four segments performance in the table.

Various models were evaluated on different datasets, as shown in Table 4. Our proposed model results are presented in Table 3. In the “Hyperpartisan News Detection (HND)” dataset, BERT achieved an accuracy of 92.00%. CogLTX achieved 94.77%, BIG BIRD scored 92.20%, and LONGFORMER achieved 94.80%. GRAPHROBERTA and ERNIE-DOC-LARGE performed even better with accuracies of 96.15% and 96.60%, respectively. Our proposed model, reservoir BERT, achieved accuracies ranging from 92.04% to 97.18% across different segments.

For the “20Newsgroups (20N)” dataset, BERT achieved an accuracy of 84.79%. reservoir BERT outperformed other models with accuracies ranging from 84.83% to 89.67% across different segments. Other models such as TextGCN, BertGAT, RoBERTaGAT, and SGC also achieved competitive accuracies.

In the “EURLEX-57K (E57K)” dataset, BERT achieved an accuracy of 73.09%. reservoir BERT achieved accuracies ranging from 68.56% to 73.97% across different segments. Other models had lower accuracies, with LONGFORMER exhibiting the lowest performance.

The proposed work demonstrates a strong performance by effectively addressing the challenge of handling lengthy sequences. To overcome this issue, the approach employs a technique called segmenting, which divides the sequences into smaller parts. Additionally, memory states from preceding segments are transferred to the current segments, allowing for recurrent capabilities within the model. Consequently, this memory passing process removes any limitations on the length of the input sequence. For the purposes of this study, a total of four segments are considered. Table 3 shows the results on segmenting, which helps to further improve the prediction accuracy on three tasks.

TABLE 2
Our RC model is comaprable with Blenderbot. The combination of our RC model
and Blenderbot outperforms Blenderbot. GBLEU is Google BLEU score.

| Model | METERO | GBLEU | BLEU | ROUGE1 | ROUGE2 | ROUGE_{L} | ROUGE_{Lsum} |
|---|---|---|---|---|---|---|---|
| Blenderbot | 24.9 | 10.1 | 7.0 | 27.5 | 10.2 | 23.0 | 23.1 |
| RC | 24.6 | 10.0 | 6.9 | 27.5 | 10.0 | 22.7 | 22.8 |
| Blenderbot + RC | 25.2 | 10.3 | 7.2 | 28.0 | 10.5 | 23.3 | 23.3 |

TABLE 3
Performance comparison of different datasets across segments

Segments

| Dataset | 1 | 2 | 3 | 4 |
|---|---|---|---|---|
| HND | 92.04 | 94.63 | 97.18 | 96.92 |
| 20N | 84.83 | 88.63 | 89.67 | 89.07 |
| E57K | 68.56 | 70.82 | 73.37 | 73.97 |

TABLE 4
Text classification on three datasets

| Model/Dataset | HND | 20N | E57K |
|---|---|---|---|
| BERT | 92.00 | 84.79 | 73.09 |
| BERT + TextRank (Park | 91.15 | 84.99 | 72.87 |
| et al., 2022) | | | |
| BERT + Random (Park | 89.23 | 84.65 | 73.22 |
| et al., 2022) | | | |
| ToBERT (Pappagari | 89.54 | 85.52 | 67.57 |
| et al., 2019) | | | |
| CogLTX (Ding et al., | 94.77 | 84.63 | 70.13 |
| 2020a) | | | |
| LONGFORMER | 94.80 | 83.39 | 54.53 |
| (Beltagy et al., 2020) | | | |
| BIG BIRD (Zaheer | 92.20 | — | — |
| et al., 2020) | | | |
| GRAPH-ROBERTA | 96.15 | — | — |
| (Xu et al., 2021) | | | |
| ERNIE-DOC-LARGE | 96.60 | — | — |
| (Ding et al., 2020b) | | | |
| ERNIE-SPARSE (Liu | 92.81 | — | — |
| et al., 2022) | | | |
| RMT BERT (Bulatov | 94.34 | — | — |
| et al., 2022) | | | |
| TextGCN (Lin et al., | — | 86.3 | — |
| 2021) | | | |
| BertGAT (Lin et al., | — | 87.4 | — |
| 2021) | | | |
| RoBERTaGAT (Lin | — | 86.5 | — |
| et al., 2021) | | | |
| SOC (Lin et al., 2021) | — | 88.5 | — |
| ZERO-BIGRU-LWAN | — | — | 0.652 |
| (Chalkidis et al., 2019) | | | |
| BIGRU-LWAN (L2V) | — | — | 0.711 |
| (Chalkidis et al., 2019) | | | |
| BIGRU-LWAN (ELMO) | — | — | 0.719 |
| (Chalkidis et al., 2019) | | | |
| Reservior BERT | 97.18 | 89.67 | 73.97 |

### 3.3 Dialogue Modeling

To assess the performance of our chatbot, we employ a test dataset that will be released along with the paper comprising 30 randomly selected conversations extracted from a larger dataset of 400,000 interactions between users and a bot. This dataset encompasses a wide range of topics, including sports, history, travel, art, music, health and wellness, general knowledge questions, and entertainment, ensuring its diversity and representativeness.

Each conversation within the test dataset is structured as a sequence of user inputs and bot responses. User inputs encompass various question types, such as yes/no inquiries, open-ended queries, and multiple-choice questions. Bot responses encompass both informative and conversational replies.

For evaluating the efficacy of our proposed approach, we adopt standard evaluation metrics commonly employed for conversational agents, juxtaposed with human references. Our evaluation encompasses metrics such as BLEU score, Rouge score, and word token error by comparing our chatbot's performance against existing responses from ChatGPT.

To assess the advancements achieved, we compare the results of our model with the baseline system, Blenderbot. This comparative analysis allows us to evaluate the improvements attained by our chatbot in terms of its ability to generate coherent and contextually appropriate responses. Experiments also show that our method outperforms the baseline method in conversational modeling.

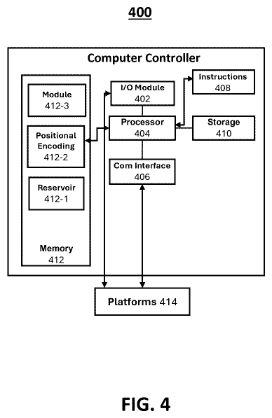

In the embodiments, FIG. 4 illustrates a computer controller 400 that may be an application-specific hardware, software, and firmware implementation of the mainframe pipeline processes depicted in FIGS. 1-3, described above. The controller 400 may include a processor 404 configured to be executed on one or more, or all the blocks of the system of FIGS. 1-3, described above.

The processor 404 can have a specific structure imparted to the processor 404 by instructions stored in the memory 412 and/or by instructions 408 fetchable by the processor 404 from a storage medium 410. The storage medium 410 can be remote and communicatively coupled to the controller 400.

The controller 400 can be a stand-alone programmable system, or a programmable module included in a larger system. For example, the controller 400 may include or be connected with external computer systems. For example, the controller 400 may include one or more hardware and/or software components configured to fetch, decode, execute, store, analyze, distribute, evaluate, and/or categorize information.

The processor 404 may include one or more processing devices or cores (not shown). In some embodiments, the processor 404 may be a plurality of processors, each having one or more cores. The processor 404, in another embodiment, may be a distributed processor. The processor 404 can execute instructions fetched from the memory 412, i.e., with reference to, among other code, instructions or data, one of memory modules 412-1, 412-2, or 412-3. Alternatively, the instructions can be fetched from the storage medium 410, or from a remote device connected to the controller 400 via the communication interface 406.

Furthermore, the communication interface 406 can also interface with processors within a computer system of the mainframe pipeline architecture. An input/output (I/O) module 402 may be configured for additional communications to or from associated local and/or remote systems of one or more platforms 414, such as the mainframe pipeline process of FIGS. 1-3.

Without loss of generality, the storage medium 410 and/or the memory 412 can include a volatile or non-volatile, magnetic, semiconductor, tape, optical, removable, non-removable, read-only, random-access, or any type of non-transitory computer-readable computer medium. The storage medium 410 and/or the memory 412 may include programs and/or other information usable by processor 404. Furthermore, the storage medium 410 can be configured to log data processed, recorded, or collected during the operation of the controller 400.

The data may be time-stamped, location-stamped, cataloged, indexed, encrypted, and/or organized in a variety of ways consistent with data storage practice. The memory modules in memory 412 may represent specialized modules for various functions described in the embodiments herein.

By way of example, the memory module 412-1 may represent a specialized module configured to implement aspects of the reservoir described above. Similarly, the memory module 412-2 may form a positional encoding module, as described with reference to one or more of FIGS. 1-3, described above. The instructions embodied in these memory modules can cause the processor 404 to perform certain operations consistent with the functions described above.

The processor 404 is a hardware device for executing software, particularly that stored in memory 412. The processor 404 can be any custom made or commercially available processor, a central processor unit (CPU), an auxiliary processor among several processors associated with the computer controller 400, a semiconductor based microprocessor (in the form of a microchip or chip set), a macroprocessor, or generally any device for executing software instructions.

The memory 412 can include any one or combination of volatile memory elements (e.g., random access memory (RAM, such as DRAM, SRAM, SDRAM, etc.)) and nonvolatile memory elements (e.g., ROM, erasable programmable read-only memory (EPROM), electronically erasable programmable read-only memory (EEPROM), programmable read-only memory (PROM)).

Memory 412 may also include removable storage such as tape, compact disc read-only memory (CD-ROM), disk, diskette, cartridge, cassette or the like, etc., and non-removable storage such as a hard disk drive (HDD).

Moreover, the memory 412 may incorporate electronic, magnetic, optical, and/or other types of storage media. Note that the memory 412 can have a distributed architecture, where various components are situated remote from one another, but can be accessed by the processor 404.

The software in memory 412 may include one or more separate programs, each of which comprises an ordered listing of executable instructions for implementing logical functions, and a suitable operating system (OS). The OS essentially controls the execution of the computer programs, and provides scheduling, input-output control, file and data management, memory management, and communication control, and related services.

If the computer controller 400 is a PC, workstation, intelligent device or the like, the software in the memory 412 may further include a basic I/O system (BIOS), omitted from this description for simplicity. The BIOS is a set of essential software routines that initialize and test hardware at startup, start the OS, and support the transfer of data among the hardware devices. The BIOS is stored in read-only memory (ROM) so that the BIOS can be executed when the computer controller 400 is activated.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for modeling variable-distanced input dependencies, comprising:
providing non-linear readouts using attentional neural networks to replace the linear readouts;
learning, via the non-linear readout reservoir, sample dependencies in the complete dataset,
wherein, the learning complements the transformer that only handles the dependencies within a sample in a short context; and
where the learning long-sequential inputs improves BERT and Blenderbot performance and significantly increases prediction accuracy in language modeling, text classification, and dialogue modelling tasks over the state-of-the-art.
